(19) United States
(12) Patent Application Publication
(10) Pub. No.: US 2012/0305789 A1
(43) Pub. Date: Dec. 6, 2012

(54) METHOD AND DEVICE FOR QUALITY CONTROL OF RADIOPHARMACEUTICALS

(76) Inventors: Maxim Kiselev, Sterling, VA (US); Scott M. Stiffler, Indianapolis, IN (US)

(21) Appl. No.: 13/486,735

(22) Filed: Jun. 1, 2012

Related U.S. Application Data
(60) Provisional application No. 61/492,180, filed on Jun. 1, 2011.

(51) Int. Cl. G01T 1/00

(52) U.S. Cl. 250/393

(57) ABSTRACT

A method and a device are provided for evaluating quality of radiopharmaceutical preparations.

### CLAIM OF PRIORITY

This application claims the benefit of priority of U.S. provisional application No. 61/492,180 filed on Jun. 1, 2011, the complete disclosure of which is incorporated herein by reference.

### TECHNICAL FIELD

The invention relates to preparation and quality control of preparations used for diagnostic imaging, in particular, radiopharmaceutical preparations such as those containing radioactive isotope of Technetium, Tc-99m and/or other radioactive isotopes used in Single Photon Emission Computed Tomography (SPECT).

### BACKGROUND

Radiopharmaceuticals formulations containing Tc-99m have found wide application in nuclear medicine. Due to a relatively short, approximately 12-hour half-life time of Tc-99m, radiopharmaceutical formulations prepared from Tc-99m have a limited shelf life and therefore they must be prepared frequently, typically at least daily and sometimes several times per day at each facility where the formulations are used. Tc-99m isotope can be conveniently produced from a relatively long lived (half-life time of approximately 66 hours) isotope of molybdenum, Mo-99, manufactured by neutron irradiation of an enriched uranium target and typically supplied immobilized on an alumina sorbent packed in a column deposited within protective lead shield, usually referred to as a “Tc-99m generator.” Tc-99m can be obtained by elution of the Tc-99m generator with diluted hydrochloric acid while Mo-99 remains in the column. Elution of the Tc-99m generator results in a Tc-99m pertechnetate solution in diluted hydrochloric acid. The solution can be subsequently mixed with a “kit” containing suitable buffer, reducing agent and a reactant. The reactant may be, for example, methoxyisobutylisonitrile. The reducing agent, typically stannous chloride, reduces the oxidation state of Tc-99m and causes it to react with the reactant or chelating agent to form the desired radiopharmaceutical compound. After preparation and dilution with a suitable buffer or isotonic saline the resulting radiopharmaceutical preparation is administered into a patient to enable imaging with a gamma ray sensitive camera. The resulting image reveals distribution of the labeled compound in the patient's body and is useful for diagnosis.

Several factors, including incomplete reduction of pertechnetate due to an insufficient amount of stannous chloride and/or re-oxidation due the presence of oxygen may lead to contamination of the radiopharmaceutical formulation with unwanted radioactive impurities. See U.S. Pat. Nos. 4,095,950 to Kahn and 4,428,908 to Ashley, et al. for detailed discussion of various impurities. Although several impurities are of some concern, in routine practice the majority of substandard Tc-99m radiopharmaceutical products involve the use of Tc-99m pertechnetate containing excessive amounts of Tc-99 (not metastable) and/or oxidizing impurities to prepare products containing relatively small amounts of stannous (see Ponto, 1998, cited from abstract). Typically, such substandard products contain an excessive amount of unreacted pertechnetate due to re-oxidation or insufficient quantity of the reducing agent. Presence of Tc-99m pertechnetate in a preparation administered into patient might distort SPECT images thus reducing image quality and complicating diagnosis.

In order to prevent use of such substandard products it is desirable to test each batch of preparation for presence of excessive amounts of Tc-99m pertechnetetate. Accordingly, numerous methods of quality control (QC) have been developed and recommended for radio pharmacological use by manufacturers of the kits intended for preparation of Tc-99m formulations. See for example package inserts for Sestamibi, Myoview® and MAG3®. Other product package inserts such as TechneScan® HDP, and Choletec® contain no recommendations for QC. However, suitable methods have been developed and are practiced by radiopharmacies. For example, Williams et al. (J Nucl Med. 1981 November; 22(11):1015-6) disclose a QC method for Tc-99m oxidronate (HDP).

Most commonly used QC methods involve Thin Layer Chromatography (TLC). See, for example, package inserts for Sestamibi and Myoview®. In one TLC method, a small sample of the radiopharmaceutical formulation, typically 1 drop, is deposited onto a TLC plate coated with a suitable sorbent, followed by the application of a suitable solvent to the bottom edge of the plate. The developed plate is then cut into multiple strips and each strip is deposited into a calibrated detector of radioactivity. Comparison of amounts of radioactivity contained in various strips enables determination of radiochemical purity (RCP).

Although accurate, TLC methods typically require approximately 30-40 min to complete each test, although in some cases the time can be reduced to a few minutes (see for example Hung et al., J Nucl Med. 1991 November; 32(11):2162-8). Additionally, all these TLC methods require numerous manual manipulations and are very difficult to automate. The frequent preparation of these formulations and the frequent testing demanded by these methods require substantial effort.

To simplify the QC process several methods based on a Solid Phase Extraction (SPE) process have been developed. The SPE process involves deposition of the radiopharmaceutical sample onto a cartridge filled with suitable sorbent, followed by passing one or more suitable solvents through the cartridge and assaying eluate and/or the residual activity in the cartridge.

Hammes et al. (J Nucl Med Technol. 2004 June; 32(2):72-8) disclose a method of quality control for 99 mTc-tetrofosmin (Myoview®) using a Sep-Pak® cartridge containing silica, alumina or reversed phase silica C-18, eluted by various concentrations and combinations of solvents with preference given to a silica cartridge eluted with a 70:30 methanol:water mixture. Use of other solvents such as saline, water, acetone, ethanol, isopropanol, dichloromethane and acetonitrile as well as other cartridges such as alumina and C-18, is mentioned; however, no details are provided for these alternative solvents and cartridge materials. In Hammes et al., the methanol:water eluate contains free pertechnetate and tetrophosmin is retained in the silica cartridge.

An alternative SPE method using C-18 Sep-Pak® cartridge is disclosed by Ramirez et al. (Nucl Med Commun. 2000 February; 21(2):199-203). Ramirez et al. employs two elutions, first with saline solution and second with absolute ethanol. In the Ramirez et al. method free pertechnetate is eluted with saline and Tc-99m tetraphosmine is eluted with ethanol.

The MAG3® package insert and Millar et al. (Nucl Med Commun. 2004 October; 25(10): 1049-51) disclose an SPE method for measuring the radiochemical purity (RCP) of 99mTc meriatide (MAG3) using a reversed phase silica Sep-Pak® C18 cartridge eluted subsequently with 1 mM hydrochloric acid followed by one or two elutions with ethanol:water mixtures containing saline of phosphate buffer. Seetharaman et al. (J Nucl Med Technol. 2006 September; 34(3):179-83) also disclose a modified SPE method for determining the radiochemical purity of Tc-99m meriatide based on the Millar et al. technique with one additional elution with pure ethanol and an alternative method using TLC with two silica gel plates, one eluted with acetate:butanone mixture and another eluted with 50% acetonitrile. Murray et al. (Nucl. Med. Commun. 2000 July; 21(7):704) compared the two methods above and concluded that neither is suitable for use because use of the SPE method leads to an underestimation of the RCP while use of TLC method leads to an overestimation of the RCP of 99Tcm-MAG3. A high performance liquid chromatography (HPLC) method was used as reference for this comparison. In addition, both methods require use of organic solvents and/or acids.

Reilly et al. (Nucl. Med. Commun. 1992 September; 13(9):664-6) disclose an SPE method for QC of Tc-99m sestamibi using a reversed phase C18 Sep-Pack® cartridge eluted with saline solution. The Tc-99m sestamibi activity is retained in the cartridge while free Tc-99m pertechnetate is eluted. Reilly et al. report that the SPE method overestimates RCP by approximately 3%. Hung et al. (Nucl. Med. Commun. 1995 February; 16(2): 99-104), attempting to reproduce these measurements, found this difference to be significantly higher, specifically 15% higher, with the C-18 SPE method producing significantly higher RCP figures than the reference TLC method when testing identical samples. Hung et al. also disclose another SPE method using alumina cartridge eluted with ethanol, in which the pertechnetate remains in the cartridge and Tc-99m sestamibi is eluted in ethanol. Alumina cartridge test is suitable for samples up to 0.1 ml and according to Hung et al. is in good agreement with reference TLC method. However, Hung et al. found that this alumina SPE method was still somewhat inaccurate and resulted in a false rejection rate of 15.4% (8 out of 52 samples that passed using reference TLC method were rejected by SPE method). In addition, Hung et al. method requires use of absolute alcohol which is prone to absorbing water, which contamination would result in inaccurate test results, thus rendering the test less robust and reliable.

While various SPE and TLC methods are disclosed in the art, all fail to achieve the degree of accuracy and simplicity needed for fast and automated QC testing of Tc-99m radiopharmaceutical preparations. Because most radiopharmacies are not limited to any one product and typically compound multiple products, it is furthermore desirable to have a method applicable to multiple products so that automated apparatus can be constructed at a minimal cost and utilized to carry out QC testing.

### SUMMARY

According to a first aspect of the invention, a method for controlling the quality of radiopharmaceutical composition is provided. The method features contacting a radiopharmaceutical sample with a sorbent including silicon dioxide, magnesium oxide, and sodium sulfate, measuring a first radioactivity value of the radiopharmaceutical sample with a radiation detector, eluting the sorbent and the radiopharmaceutical sample with an aqueous eluent to provide the radiopharmaceutical sample with a residual radioactivity, measuring a second radioactivity value of the residual radioactivity, and determining radiochemical purity of the radiopharmaceutical sample based on the first and second radioactivity values.

A second aspect of the invention provides a method for quality control of radiopharmaceutical preparations. A radiopharmaceutical sample is combined with a sorbent including silicon dioxide, magnesium oxide, and sodium sulfate. The radiopharmaceutical sample is selected from Tc-99m 2-methoxy-isobutylisonitrile, Tc-99m tetrofosmin, Tc-99m oxidronate, Tc-99m mebrofenin, Tc-99m mertiatide, and/or a radiopharmaceutical equivalent thereof. A first radioactivity value of the radiopharmaceutical sample is measured with a radiation detector, and the sorbent and the radiopharmaceutical sample are eluted with an aqueous eluent to provide the radiopharmaceutical sample with a residual radioactivity. A second radioactivity value of the residual radioactivity is measured, and a radiochemical purity of the radiopharmaceutical sample is determined based on the first and second radioactivity values.

In accordance with a third aspect to the invention, a method is provided for quality control of radiopharmaceutical preparations. According to this aspect, a radiopharmaceutical sample is combined with a sorbent including silicon dioxide, magnesium oxide, and sodium sulfate in a column. The radiopharmaceutical sample is selected from Tc-99m 2-methoxy-isobutylisonitrile, Tc-99m tetrofosmin, Tc-99m oxidronate, Tc-99m mebrofenin, Tc-99m mertiatide, and/or a radiopharmaceutical equivalent thereof. A first radioactivity value of the radiopharmaceutical sample is measured with a radiation detector, and the sorbent and the radiopharmaceutical sample are eluted with an effective amount of aqueous eluent to substantially remove radioactive impurities from the radiopharmaceutical sample and to provide the radiopharmaceutical sample with a residual radioactivity. A second radioactivity value of the residual radioactivity is measured, and radiochemical purity of the radiopharmaceutical sample is determined based on the first and second radioactivity values.

Other aspects of the invention, including apparatus, systems, methods, and the like which constitute part of the invention, will become more apparent upon reading the following detailed description of the exemplary embodiments and viewing the drawings.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a schematic illustrating the introduction of a radiopharmaceutical preparation sample into a SPE cartridge according to a step of an exemplary embodiment.

FIG. 2 is a schematic representation of an exemplary apparatus for eluting the radiopharmaceutical preparation according to a further step of the exemplary embodiment.

### DETAILED DESCRIPTION OF EXEMPLARY EMBODIMENTS

Reference will now be made in detail to exemplary embodiments and methods as illustrated in the accompanying drawings, in which like reference characters designate like or corresponding parts throughout the drawings. It should be noted, however, that the invention in its broader aspects is not necessarily limited to the specific details, representative devices and methods, and illustrative examples shown and described in connection with the exemplary embodiments and methods. All specific materials, sizes, dimensions, suppliers and parts mentioned are provided to enable reproduction of exemplary embodiments and are not limiting.

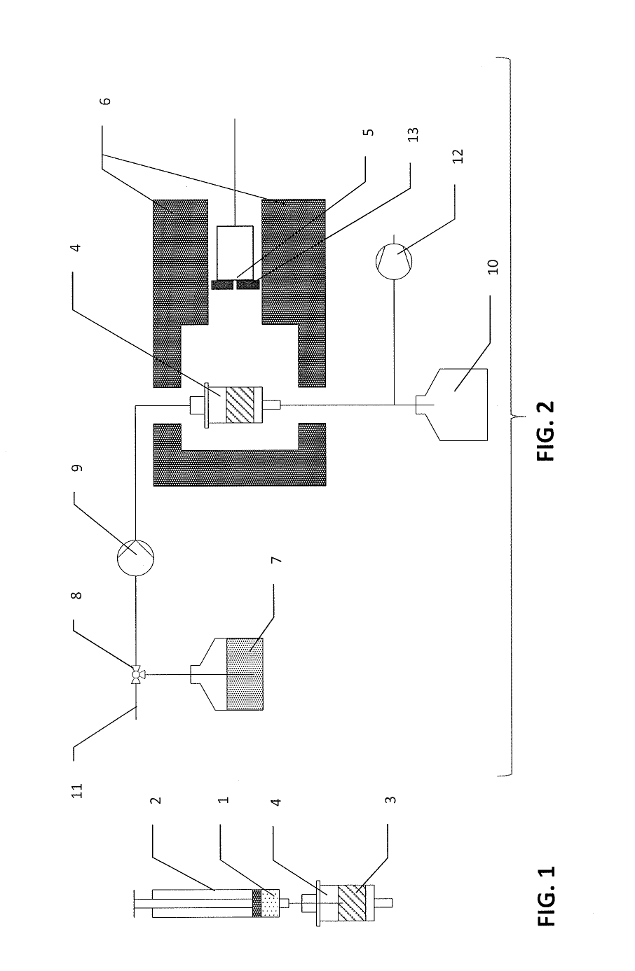

Referring to FIG. 1, a sample 1 of a radiopharmaceutical preparation is introduced from a syringe 2 into a sorbent 3 contained within a SPE cartridge 4. Examples of radiopharmaceutical preparations that may be subjected to quality control in accordance with exemplary embodiments described herein include Tc-99m 2-methoxy-isobutylisonitrile (e.g., Setsamibi, Cardiolite® or its equivalent); Tc-99m tetrofosmin (e.g., Myoview® or its equivalent); Tc-99m oxidronate (e.g., HDP, TechneScan® HDP or its equivalent); Tc-99m Mebrofenin (e.g., Choletec® or its equivalent); Tc-99m mertiatide (e.g., TechneScan MAG3® or its equivalent); and other Tc-99m compounds. As referred to herein, “equivalent” means a recognized FDA equivalent.

According to an exemplary embodiment, the sorbent 3 contains at least 60% by weight of silicon dioxide at least 10% by weight of magnesium oxide (magnesia), and up to 1% by weight of sodium sulfate. An exemplary commercially available sorbent 3 is Florisil sorbent supplied by Floridin Co. of Englewood, Colo. Florisil® sorbent contains 84% by weight of silica gel, 15% by weight of magnesium oxide, and up to 1% by weight of sodium sulphate in a powder with 150-250 μm (micrometers) particle size. It should be understood that other weight ratios and particle sizes may be selected according to this exemplary embodiment. The sorbent 3 may contain other components, such as activated magnesium silicate.

An exemplary commercially available cartridge 4 is the SPE-ed™ supplied by Applied Separations of Allentown Pa. The cartridge 4 may contain, for example, between 100 mg and 2 g of the sorbent 3. The amount of sorbent 3 contained in the cartridge 4 depends on the sample 1 volume. In general, it is preferable to minimize sample volume relative to the sorbent amount. For example, for a 0.1 ml sample volume, an exemplary amount of sorbent 3 is at least 0.5 g. While smaller samples are generally preferred to reduce waste, the larger samples are easier to accurately measure using common syringes, and samples of up to 0.2 ml (although more may be used) can be accurately analyzed according to this exemplary embodiment.

The syringe 2 may be selected from a number of commonly used disposable syringes with volume of, for example, 0.1 ml to 5 ml having a needle with sufficient length, e.g., 0.5″ (inch) or greater, to allow the sample 1 to reach the sorbent 3 in the cartridge 4.

After depositing the sample 1 in the sorbent 3, the needle of the syringe 2, now empty (not shown), is removed and the cartridge 4 containing the radioactive sample 1 with the sorbent 3 is placed onto an apparatus depicted in FIG. 2 within close proximity to a radiation detector 5. As shown in FIG. 2, the radiation detector 5 is typically surrounded by radiation shielding 6 made of lead or tungsten or other known or suitable materials designed to reduce ambient background radiation which may be present in the surrounding environment, which may be, for example, a laboratory.

The radiation detector 5 may be constructed of a 10 mm scintillating crystal having cylindrical shape with 10 mm diameter and 5 mm thickness made of sodium iodide doped with thallium and optically coupled to a suitable size photomultiplier tube (PMT) (for example having a diameter of about 12 mm), a PIN diode, or an avalanche diode. Other radiation detector dimensions, arrangements, and materials may be used. For example, alternative materials suitable for scintillating detector include cesium iodide and lead tungstanate. An exemplary commercially available PMT is model H6520 supplied by Hamamatsu US of Bridgewater N.J. Care should be taken to protect the radiation detector 5 from ambient light. A suitable bias voltage for this PMT is 1000V.

The radiation detector 5 may be electrically connected to a high voltage source (e.g., 1000V) and an electronic circuit capable of counting the number of detected gamma photons emanating from the sample 1 within the cartridge 4. A scaler circuit, equipped at least 12 bit binary counter, allows scaling of the counts to reduce a count rate to, for example, 1,000 cps (counts per second) or less suitable for recording by a programmable logic controller (PLC). For example, a scaling of 1:8 applied to 1,000 cps count rate would result in an apparent count rate of 125 cps. The PLC, such as model FX3U, may be used to retain counts, perform necessary computations and produce a report. The PLC is preferably interfaced with a Human Machine Interface (HMI) such as model GT1020LBL to accept operator inputs, perform necessary automated functions and report the results. Suitable PLC and HMI models are supplied by Mitsubishi Electric Corporation of Tokyo, Japan.

The position of the radiation detector 5 relative to the cartridge 4 and scaling are selected to produce sufficient number of counts, preferably over 1,000 counts per second (before scaling), while not overloading the detector 5 with an excessive count rate. It is desirable to maintain sample activity and distance so that the count rate is below 10,000 counts per second (before scaling) and the apparent count rate (after scaling) is at about 1,000 cps. The distance may be determined based on the activity of the sample 1 being measured. Samples of about 1 mCi can be adequately measured by placing the radiation detector 5 at a distance of 5 and 10 cm apart from the sample 1. Generally, the distance is increased for higher activity samples and reduced for lower activity samples.

After recording an initial sample radioactivity measurement, suitable eluent 7 is passed through a three port valve 8. As shown in FIG. 2, a metering pump 9 may be employed to pump the eluent 7 through the cartridge 4 and collect the resulting eluate in a collection vessel 10. The valve 8 may be a model LFRX0500650BE and the micro metering pump 9 may be model LPLA2430350L, both supplied by the Lee Company of Westbrook Conn. The micro metering pump 9 may be operated to dispense, for example, 50 micro-liters of eluent with each stroke at 1 stroke per second, with a resultant flow rate of about 3 ml/min. An excessively high flow rate may lead to erroneous results, whereas an excessively low flow rate may lead to unnecessary increase of a test time. In an exemplary embodiment about 4 ml of eluent 7 is used for sample sizes described herein.

Water or isotonic saline may be used to elute unreacted pertechnetate. Isotonic saline solution containing 0.9% of sodium chloride in water is an exemplary eluent. Other water-based solutions and mixtures may be suitable such as pure water. Depending on the amount of sorbent 3 used and the dimensions of the cartridge 4, the volume of eluent 7 required may vary, for example, from 2 ml to 10 ml. It was found that 4 ml of saline is sufficient to remove Tc-99m pertechnetate deposited into a 0.5 g Florisil® cartridge.

After passing a sufficient volume of eluent to remove Tc-99m pertechnetate and other hydrophilic impurities from the cartridge 4, the pump 9 is stopped and the valve 8 is switched to allow air intake from an open port 11. A vacuum pump 12 is switched on for 2-5 seconds, for example, to evacuate the collection vessel 10 and cause any remaining liquid in the cartridge 4 to flow into the collection vessel 10. This step is not essential; however, it is helpful to prevent possible radioactive contamination in the process of cartridge removal.

The residual activity remaining in the cartridge 4 is measured using the same radiation detector 5 positioned in the same position with respect to the detector 5 as employed in the initial measurement prior to the eluting treatment. The radiochemical purity (RCP) of the Tc-99m preparation may be calculated by dividing this residual activity measurement by the initial radioactivity measurement previously measured for the same sample 1. A correction for normal background can be optionally made to increase accuracy of the measurement. Normal background level is insignificant (e.g., less than 0.1% of the radioactivity being measured) and may be ignored in most cases.

A collimator 13 made of lead, tungsten or other heavy metal material with thickness sufficient to block gamma radiation, typically 3 mm, optionally may be placed between the cartridge 4 and the detector 5. Use of the collimator 13 is advantageous when it is desirable to use relatively high amounts of radioactivity. The collimator 13 is also helpful in reducing effects of variable geometry of the sample 1 caused for example by the migration of the radioactive fluid during elution and redistribution of the radioactive sample 1 within the cartridge 4.

Generally, a sufficiently pure sample for SPECT usage will produce a RCP ratio of at least about 0.95 or greater according to this method. The RCP percentage is obtained by multiplying the RCP ratio by 100, e.g., a 0.95 ratio equals 95% radiochemical purity.

It may be possible, though not mandatory, to carry out quality control methods of embodiments of the invention in as little time as about 2 minutes. The method may be practiced to not only accurately detect, but to quantify, free pertechnetate and other water-soluble radioactive impurities which are known to be likely present in Tc-99m radiopharmaceutical preparations and may be detrimental to the quality of the diagnostic imaging procedures. The method is applicable to a variety of preparations thus making it convenient to utilize in a radiopharmacy setting.

Another useful feature of embodiments described herein is that they do not require use of toxic solvents or acids. Likewise, use of absolute alcohol and/or other moisture sensitive reagents is not necessary, thus making the exemplified method more robust and less vulnerable to errors resulting from reagent contamination.

### EXAMPLES

### Example 1

A sample of about 0.05 ml of Tc-99m Myoview® was loaded onto a SPE-ed Florisil® cartridge and counted for 10 sec using a 10 mm CsI scintillating crystal attached to a PMT and placed at a distance of about 25 mm from the cartridge, followed by elution with 4 ml of isotonic saline. An average count rate of 114.4 cps (after 1:16 scaling) was obtained before elution and a count rate of 113.7 cps was obtained after elution. Thus, RCP was 99.4% as determined by the elution method. The same sample was analyzed using a conventional TLC method as a reference. The RCP determined using the conventional TLC method was 99.9%. Thus, the elution method result was in agreement with the TLC reference method.

### Example 2

A sample of about 0.05 ml of Tc-99m Sestamibi was loaded onto an SPE-ed Florisil® cartridge and counted using same PMT detector in similar conditions followed by elution with 4 ml of isotonic saline. The same sample was analyzed using a conventional TLC method as a reference. The RCP determined using the conventional TLC method was 99.8%. The ratio of activity measured after and before elution was 100%, which was considered as being in agreement with the TLC reference method.

### Example 3

A sample of 0.05 ml of Tc-99m DTPA was loaded onto a SPE-ed Florisil® cartridge and counted using same detector followed by elution with 4 ml of isotonic saline. The same sample was analyzed using a conventional TLC method as a reference. The RCP determined using the conventional TLC method was 99.8%. The ratio of activity measured after and before elution was 101%, which was considered as being in agreement with the TLC reference method.

### Example 4

4 samples of about 0.02-0.05 ml of Tc-99m Sestamibi were loaded onto 4 different SPE-ed Florisil® cartridges and counted using same PMT detector in similar conditions, but with a 3 mm (⅛″ thick) lead collimator with a hole diameter of 3 mm (⅛″), attached to the detector, followed by elution with 4 ml of isotonic saline. The same sample was analyzed using a conventional TLC method as a reference. The count rate was between 207 and 591 cps (with 1:8 scaling). The RCP determined using the conventional TLC method was between 99 and 100%. The ratio of activity measured after and before elution were 98, 93, 97, 97% respectively, which was considered as being in agreement with the TLC reference method.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Although only a few embodiments have been disclosed in detail above, other embodiments are possible and the inventors intend these to be encompassed within this specification and the scope of the appended claims. The specification describes specific examples to accomplish a more general goal that may be accomplished in another way. Modifications and equivalents will be apparent to practitioners skilled in this art and are encompassed within the spirit and scope of the appended claims and their appropriate equivalents. This disclosure is intended to be exemplary, and the claims are intended to cover any modification or alternative which might be predictable to a person having ordinary skill in the art.

Only those claims which use the words “means for” are to be interpreted under 35 U.S.C. §112, sixth paragraph. Moreover, no limitations from the specification are to be read into any claims, unless those limitations are expressly included in the claims.

What is claimed is:

1. A method for quality control of radiopharmaceutical preparations, comprising:
combining a radiopharmaceutical sample and a sorbent comprising silicon dioxide, magnesium oxide, and sodium sulfate;
measuring a first radioactivity value of the radiopharmaceutical sample with a radiation detector;
eluting the sorbent and the radiopharmaceutical sample with an aqueous eluent to provide the radiopharmaceutical sample with a residual radioactivity;
measuring a second radioactivity value of the residual radioactivity; and
determining radiochemical purity of the radiopharmaceutical sample based on the first and second radioactivity values.

2. The method of claim 1, wherein the radiopharmaceutical sample contacted with the sorbent is located in a column, and wherein said eluting is conducted in the column.

3. The method of claim 1, wherein said determining of the radiochemical purity comprises dividing the first radioactivity value by the second radioactivity value.

4. The method of claim 1, wherein said eluting comprises passing sufficient aqueous eluent through the sorbent and the radiopharmaceutical sample to remove a substantial portion of radioactive impurities.

5. The method of claim 1, wherein the sorbent comprises at least 60 wt % of silicon dioxide, at least 10 wt % of magnesium oxide, and up to 1 wt % of sodium sulfate.

6. The method of claim 5 wherein the sorbent further comprises activated magnesium silicate.

7. The method of claim 1 wherein said aqueous eluent comprises isotonic saline.

8. The method of claim 1 wherein the radiopharmaceutical sample has a volume in a range of 0.01 ml to about 0.2 ml.

9. The method of claim 9, wherein said eluting is performed with 2 ml to 10 ml of the aqueous eluent.

10. The method of claim 10 wherein the sorbent has a weight in a range of 100 mg to 2 g.

11. The method of claim 1 wherein the radiation detector comprises a scintillator optically coupled with a PMT tube.

12. The method of step 11 wherein the scintillator comprises cesium iodide crystal.

13. A method for quality control of radiopharmaceutical preparations, comprising:
combining a radiopharmaceutical sample and a sorbent comprising silicon dioxide, magnesium oxide, and sodium sulfate, the radiopharmaceutical sample comprising a member selected from the group consisting of Tc-99m 2-methoxy-isobutylisonitrile, Tc-99m tetrofosmin, Tc-99m oxidronate, Tc-99m mebrofenin, Tc-99m mertiatide, and a radiopharmaceutical equivalent thereof;
measuring a first radioactivity value of the radiopharmaceutical sample with a radiation detector;
eluting the sorbent and the radiopharmaceutical sample with an aqueous eluent to provide the radiopharmaceutical sample with a residual radioactivity;
measuring a second radioactivity value of the residual radioactivity; and
determining radiochemical purity of the radiopharmaceutical sample based on the first and second radioactivity values.

14. The method of claim 13, wherein the radiopharmaceutical sample contacted with the sorbent is located in a column, and wherein said eluting is conducted in the column.

15. The method of claim 13, wherein the sorbent comprises at least 60 wt % of silicon dioxide, at least 10 wt % of magnesium oxide, and up to 1 wt % of sodium sulfate.

16. The method of claim 15 wherein the sorbent further comprises activated magnesium silicate.

17. The method of claim 13, wherein said aqueous eluent comprises isotonic saline.

18. The method of claim 13, wherein said eluting is performed with 2 ml to 10 ml of the aqueous eluent.

19. The method of claim 13, wherein the radiation detector comprises a scintillator optically coupled with a PMT tube.

20. A method for quality control of radiopharmaceutical preparations, comprising:
combining a radiopharmaceutical sample and a sorbent comprising silicon dioxide, magnesium oxide, and sodium sulfate in a column, the radiopharmaceutical sample comprising a member selected from the group consisting of Tc-99m 2-methoxy-isobutylisonitrile, Tc-99m tetrofosmin, Tc-99m oxidronate, Tc-99m mebrofenin, Tc-99m mertiatide, and a radiopharmaceutical equivalent thereof;
measuring a first radioactivity value of the radiopharmaceutical sample with a radiation detector;
eluting the sorbent and the radiopharmaceutical sample with an effective amount of aqueous eluent to substantially remove radioactive impurities from the radiopharmaceutical sample and to provide the radiopharmaceutical sample with a residual radioactivity;
measuring a second radioactivity value of the residual radioactivity; and
determining radiochemical purity of the radiopharmaceutical sample based on the first and second radioactivity values.
